(19) United States
(12) Patent Application Publication
(10) Pub. No.: US 2004/0230544 A1
(43) Pub. Date: Nov. 18, 2004

(54) Franking apparatus and method

(75) Inventor: Raymond John Herbert, Leigh-on-Sea (GB)

Correspondence Address: Shoemaker and Mattare, Ltd., 2001 Jefferson Davis Highway, Arlington, VA, 22202, US

(73) Assignee: Neopost Industrie SA, Bagneux (FR)

(21) Appl. No.: 10/768,733

(22) Filed: Feb. 2, 2004

(30) Foreign Application Priority Data
Jan. 31, 2003 (GB) 0302277.9

(51) Int. Cl. G06F 17/00

(52) U.S. Cl. 705/401

(57) ABSTRACT

A franking apparatus for and a method of franking mail items with postage indicia for one of a plurality of mail carriers, the apparatus comprising: a plurality of carrier print stores, each being assigned to a respective one of the carriers and for storing print information unique to the respective carrier; a common print store for storing print information common to each of the carriers; a printing module including a printer for printing postage indicia for mail items; and a control module for controlling operation of the apparatus to frank mail items with postage indicia for selected ones of the carriers, wherein each postage indicium includes a carrier-specific element derived utilizing print information from the carrier print store for the respective carrier and a common element derived utilizing print information from the common print store.

### FIELD OF THE INVENTION

The present invention relates to a multi-carrier franking apparatus and method which provides for the franking of mail items with postage indicia for one of a plurality of mail carriers.

### BACKGROUND OF THE INVENTION

Existing franking machines are configured to provide for the franking of mail items which are to be handled by a single mail carrier, with the postage indicia having a format specified by the respective mail carrier.

It is an aim of the present invention to provide a franking apparatus and method which provides for the franking of mail items with postage indicia for one of a plurality of mail carriers.

In providing for the franking of mail items with postage indicia for one of a plurality of mail carriers, the facility is provided to enable the most suitable mail carrier to be utilized, for example, by reason of cost, geographic destination, speed of delivery, etc.

### SUMMARY OF THE INVENTION

In one aspect the present invention provides a franking apparatus for franking mail items with postage indicia for one of a plurality of mail carriers, the apparatus comprising: a plurality of carrier print stores, each being assigned to a respective one of the carriers and for storing print information unique to the respective carrier; a common print store for storing print information common to each of the carriers; a printing module including a printer for printing postage indicia for mail items; and a control module for controlling operation of the apparatus to frank mail items with postage indicia for selected ones of the carriers, wherein each postage indicium includes a carrier-specific element derived utilizing print information from the carrier print store for the respective carrier and a common element derived utilizing print information from the common print store.

In one embodiment the control module is configured to allow for selection of the carrier by a user.

Preferably, the control module generates a ranked list of the carriers, from which the carrier is selected.

More preferably, the ranked list of carriers is determined according to at least one user-defined preference.

In another embodiment the control module is configured automatically to select the carrier.

Preferably, the carrier is selected according to at least one user-defined preference.

In one embodiment the control module stores user-defined preferences for users, and is configured to require the input of a user-identification code, such that the user-defined preferences for carrier selection are determined from the user-identification code.

Preferably, the user-identification code comprises a personal identification number (PIN).

In one embodiment the control module is configured to frank a batch of mail items with postage indicia for the same carrier.

Preferably, the apparatus further comprises: a plurality of carrier accounting stores, each being assigned to a respective one of the carriers and for storing postage information for the respective carrier.

More preferably, each of the carrier accounting stores includes a credit register for storing a value representative of a value of postage available to be printed for the respective carrier.

Yet more preferably, the apparatus further comprises: a bank credit store including a bank credit register for storing a common banked value of credit which is utilized in crediting the credit registers of the carrier accounting stores.

In one embodiment the control module is configured to re-credit the credit registers of the carrier accounting stores in relative amounts corresponding to previous usage of postage value for each of the respective carriers.

In another embodiment the control module is configured to re-credit the credit registers of the carrier accounting stores in relative amounts as defined by a user.

Preferably, at least ones of the postage indicia include a banner element.

In one embodiment the banner element is common to all of the carriers.

In another embodiment the banner element is unique to the respective carrier.

Preferably, the printing module includes a sorter for sorting franked mail items by carrier.

In another aspect the present invention provides a method of franking mail items with postage indicia for one of a plurality of mail carriers, the method comprising the steps of: storing print information unique to each of the carriers; storing print information common to each of the carriers; for a mail item, selecting one of the carriers; generating a carrier-specific element utilizing the unique print information for the respective carrier; generating a common element utilizing the common print information; and franking the mail item with a postage indicium including the carrier-specific element and the common element.

In one embodiment the carrier selection step comprises the step of: a user selecting one of the carriers.

Preferably, the carrier selection step comprises the steps of: generating a ranked list of the carriers; and a user selecting one of the carriers.

More preferably, the ranked list of carriers is determined according to at least one user-defined preference.

In another embodiment the carrier selection step comprises the step of: automatically selecting one of the carriers.

Preferably, the carrier is selected according to at least one user-defined preference.

In one embodiment the method further comprises the steps of: storing user-defined preferences for users; inputting a user-identification code; and determining the user-defined preferences for carrier selection from the user-identification code.

Preferably, the user-identification code comprises a personal identification number (PIN).

In one embodiment a batch of mail items is franked with postage indicia for the same carrier.

Preferably, the method further comprises the steps of: maintaining credit registers for the respective carriers, each credit register storing a value representative of a value of postage available to be printed for the respective carrier; and maintaining a bank credit register storing a common banked value of credit which is utilized in crediting the respective credit registers.

In one embodiment the method further comprises the step of: re-crediting the credit registers in relative amounts corresponding to previous usage of postage value for each of the respective carriers.

In another embodiment the method further comprises the step of: re-crediting the credit registers in relative amounts as defined by a user.

Preferably, at least ones of the postage indicia include a banner element.

In one embodiment the banner element is common to all of the carriers.

In another embodiment the banner element is unique to the respective carrier.

Preferably, the method further comprises the step of: automatically sorting franked mail items by carrier.

### BRIEF DESCRIPTION OF THE DRAWINGS

A preferred embodiment of the present invention will now be described hereinbelow by way of example only with reference to the accompanying drawings, in which:

FIG. 1 illustrates a franking apparatus in accordance with a preferred embodiment of the present invention; and

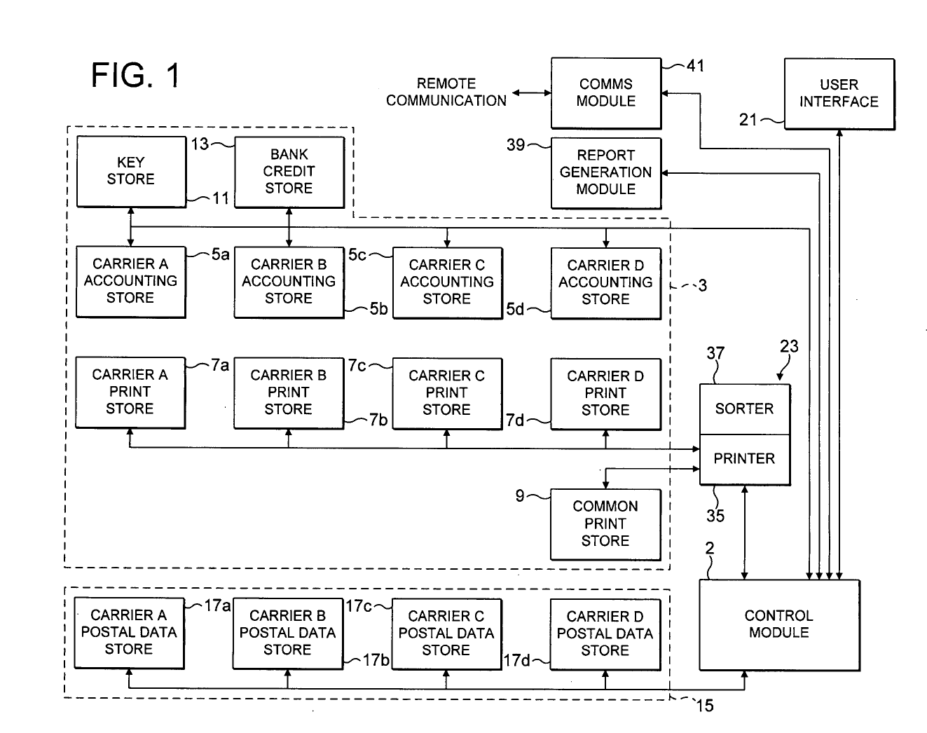

FIG. 2 illustrates a mail item franked with a postage indicium for one exemplary mail carrier as supported by the franking apparatus of FIG. 1.

### DETAILED DESCRIPTION OF THE PREFERRED EMBODIMENT

In this embodiment the franking apparatus is configured as a stand-alone franking machine which can, if desired, be interfaced to a personal computer (PC), but in other embodiments could comprise a peripheral which is interfaced to a PC. In this embodiment the franking apparatus is configured to print postage indicia onto mail items either directly or indirectly, through the use of labelling.

The franking apparatus comprises a control module 2 for controlling the operation of the apparatus to print franking impressions corresponding to one of a plurality of, here first to fourth, mail carriers, designated as Carrier A, Carrier B, Carrier C and Carrier D. As will be described in more detail hereinbelow, the franking apparatus has a plurality of modes of operation.

In this embodiment the franking apparatus requires each user to input an identification code, such as a personal identification number (PIN). Through assigning user preferences to the identification codes, the input identification code provides for the determination of the user preferences, which user preferences can be utilized in selecting the mail carrier for any mail item, as will be described in more detail hereinbelow.

In one mode of operation, the mail carrier to be utilized for each mail item is manually selected by a user from the plurality of supported mail carriers.

In one embodiment the mail carriers which are capable of handling a mail item are identified based on at least one mailing characteristic, such as weight, size, cost of delivery, speed of delivery, kind of delivery, for example, signed for delivery, and geographic destination, and subsequently presented to a user for selection. Typically, each mail carrier will only be able to, or may only wish to, handle mail items of a particular weight or size and to particular destinations, and provide a particular speed or kind of delivery.

In a preferred embodiment the mail carriers are ranked according to user preferences, for example, ranked according to at least one mailing characteristic, typically based on one or both of cost and speed of delivery, or ranked according to the carrier company, where a user has a preference for one mail carrier over another mail carrier, particularly when delivery factors, such as the cost, speed and kind of delivery, are the same for the mail carriers.

In another mode of operation, the mail carrier to be utilized for each mail item is automatically identified based on at least one mailing characteristic, such as weight, size, cost of delivery, speed of delivery, kind of delivery, for example, signed for delivery, and destination.

In a preferred embodiment the at least one mailing characteristic is determined by user preferences.

In one embodiment, where franking batches of identical mail items each having the same postal requirements, that is, geographic destination, weight and size, the user can configure the franking apparatus to determine the mail carrier for a first mail item in the batch and treat each of the subsequent mail items in the batch similarly.

The franking apparatus further comprises a first memory module 3 which includes a plurality of memory stores 5, 7, 9, 11, 13. In this embodiment the first memory module 3 is provided by a non-volatile memory (NVM).

The first memory module 3 includes a plurality of, here first to fourth, carrier accounting stores 5a, 5b, 5c, 5d assigned to the respective supported mail carriers, which carrier accounting stores 5a, 5b, 5c, 5d each include postage information registers for storing postage information, in this embodiment including a credit register for storing a value representative of the value of postage available to be printed, here a descending credit register, a tote register for storing a value representative of the total value of postage dispensed by the apparatus for the respective mail carrier and an item count of the number of mail items to which postage value has been applied for the respective mail carrier, and key registers for storing cryptographic keys utilized in dispensing postage value in the postage indicia for the respective mail carriers. In this embodiment the carrier accounting stores 5a, 5b, 5c, 5d are duplicated.

The first memory module 3 includes a plurality of, here first to fourth, carrier print stores 7a, 7b, 7c, 7d, each for storing print information unique to a respective one of the supported mail carriers.

The first memory module 3 includes a common print store 9 for storing print information to be utilized commonly in the postage indicia, which print information is common to each of the supported mail carriers.

The first memory module 3 includes a key store 11 for storing cryptographic keys utilized in operation of the apparatus.

The first memory module 3 includes a bank credit store 13 which includes a bank credit register for storing a common banked value of credit which is utilizable in crediting the credit registers of respective ones of the carrier accounting stores 5a, 5b, 5c, 5d for each of the mail carriers.

In this embodiment the franking apparatus is configured such that, in a re-crediting operation with an external agent, only the bank credit register of the bank credit store 13 is re-credited with postage value, with the postage value in the bank credit register of the bank credit store 13 being utilizable to credit the credit registers in the carrier accounting stores 5a, 5b, 5c, 5d.

With this configuration, it is envisaged that the bank credit store 13 will be re-credited by a trusted third party, that is, a third party who is trusted by each of the respective mail carriers.

In one re-crediting mode, the franking apparatus is configured such that the credit registers in the carrier accounting stores 5a, 5b, 5c, 5d for each of the respective mail carriers are re-credited in relative amounts corresponding to previous usage of postage value for each of the respective mail carriers.

In another re-crediting mode, the franking apparatus is configured such as to enable the credit registers in the carrier accounting stores 5a, 5b, 5c, 5d for each of the respective mail carriers to be re-credited in an amount specified by the user.

In another embodiment the franking apparatus can be configured such that, in a re-crediting operation, the credit registers in the carrier accounting stores 5a, 5b, 5c, 5d are re-credited directly by one or more third parties, typically the respective mail carriers.

The franking apparatus further comprises a second memory module 15 which includes a plurality of, here first to fourth, carrier postal data stores 17a, 17b, 17c, 17d, each for storing postal data information for a respective one of the supported mail carriers. In this embodiment the postal data information includes service tables for each of the services supported by the respective mail carriers and rate tables for each of the supported services.

The franking apparatus further comprises a user interface 21 which is operably connected to the control module 2 to provide for user control of the apparatus. In this embodiment the user interface 21 includes a display and a keyboard. In one embodiment the display could be configured to provide a touch screen.

The franking apparatus further comprises a print module 23 which is operably connected to the control module 2 and the first memory module 3 for printing postage indicia 25 on mail items.

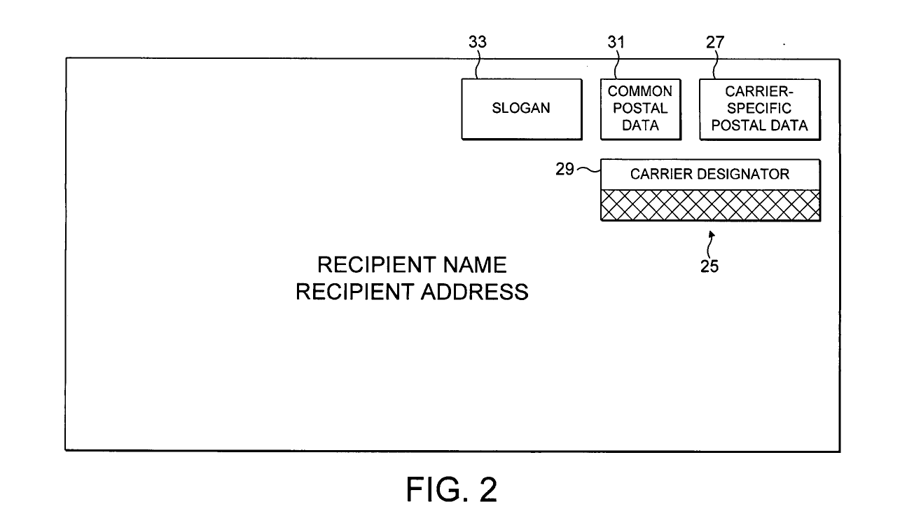

In this embodiment, as illustrated in FIG. 2, each postage indicium 25 includes a first, carrier-specific element 27 which is unique to the respective mail carrier, a second, carrier-designating element 29 which designates the respective mail carrier, such as the name of the mail carrier or a logo representing the mail carrier, and a third, common element 31 which is common to each of the supported mail carriers.

The carrier-specific element 27 includes postal information as specified by the respective mail carrier and presented in a form as specified by the respective mail carrier, such as being cryptographically signed or encrypted and optionally including human-readable information.

The carrier-designating element 29 which designates the respective mail carrier can be the name of the mail carrier or a logo representing the mail carrier.

The common element 31, which is common to each of the supported mail carriers, includes postal information as commonly specified by the supported mail carriers and presented in a form as commonly specified by the supported mail carriers, such as being cryptographically signed or encrypted and optionally including human-readable information. Through the provision of commonly-specified postal information in a commonly-specified format, the processing of the postal information, particularly as regards cryptographic processing, is simplified.

Also in this embodiment, again as illustrated in FIG. 2, each postage indicium 25 can include a fourth, banner element 33 as a banner, in particular a slogan. In one embodiment the banner element 33 can be common to all mail items, for example, as a designator of the sender, in which case the print data for the banner element 33 is stored in the common print store 9. In another embodiment the banner element 33 can be unique to the respective mail carrier, such as an advertising slogan placed by the respective mail carrier, in which case the print data is stored in the respective ones of the carrier print stores 7a, 7b, 7c, 7d.

In this embodiment the printing module 23 includes a printer 35 for printing postage indicia 25 on mail items and a sorter 37 for sorting mail items according to mail carrier, and in a preferred embodiment by service. With this configuration, users do not have to sort the franked mail items; the mail items being pre-sorted and ready for collection by, or delivery to, the respective mail carrier.

In another embodiment the printing module 23 can include only a printer 35 for printing postage indicia 25 on mail items. In one embodiment the printing module 23 can be configured to provide a user prompt, such as one of an audible or visual message, to prompt a user to the franking of mail items with postage indicia 25 for different mail carriers. With this configuration, a user can extract mail items as franked, and collect the franked mail items according to mail carrier.

The apparatus further comprises a report generation module 39 which is operably connected to the control module 2 for generating reports, including mail carrier accounting reports regarding transactions for each of the respective mail carriers, summary accounting reports regarding postage transactions by the apparatus, and bank accounting reports of transactions by the bank credit store 13.

The apparatus further comprises a communications module 41 which is operably connected to the control module 2 for enabling communication with remote systems, including the vendor of the franking apparatus, the mail carriers and any trusted third parties, such as in a re-crediting operation.

Finally, it will be understood that the present invention has been described in its preferred embodiments and can be modified in many different ways without departing from the scope of the invention as defined by the appended claims.

For example, the present invention finds application in authenticating postage value as applied to any medium, for example, as written to tags, and not just the printing of franking impressions on mail items.

1. A franking apparatus for franking mail items with postage indicia for one of a plurality of mail carriers, the apparatus comprising:
a plurality of carrier print stores, each being assigned to a respective one of the carriers and for storing print information unique to the respective carrier;
a common print store for storing print information common to each of the carriers;
a printing module including a printer for printing postage indicia for mail items; and
a control module for controlling operation of the apparatus to frank mail items with postage indicia for selected ones of the carriers, wherein each postage indicium includes a carrier-specific element derived utilizing print information from the carrier print store for the respective carrier and a common element derived utilizing print information from the common print store.

2. The apparatus of claim 1, wherein the control module is configured to allow for selection of the carrier by a user.

3. The apparatus of claim 2, wherein the control module generates a ranked list of the carriers, from which the carrier is selected.

4. The apparatus of claim 3, wherein the ranked list of carriers is determined according to at least one user-defined preference.

5. The apparatus of claim 1, wherein the control module is configured automatically to select the carrier.

6. The apparatus of claim 5, wherein the carrier is selected according to at least one user-defined preference.

7. The apparatus of claim 4, wherein the control module stores user-defined preferences for users, and is configured to require the input of a user-identification code, such that the user-defined preferences for carrier selection are determined from the user-identification code.

8. The apparatus of claim 7, wherein the user-identification code comprises a personal identification number (PIN).

9. The apparatus of claim 1, wherein the control module is configured to frank a batch of mail items with postage indicia for the same carrier.

10. The apparatus of claim 1, further comprising:
a plurality of carrier accounting stores, each being assigned to a respective one of the carriers and for storing postage information for the respective carrier.

11. The apparatus of claim 10, wherein each of the carrier accounting stores includes a credit register for storing a value representative of a value of postage available to be printed for the respective carrier.

12. The apparatus of claim 11, further comprising:
a bank credit store including a bank credit register for storing a common banked value of credit which is utilized in crediting the credit registers of the carrier accounting stores.

13. The apparatus of claim 12, wherein the control module is configured to re-credit the credit registers of the carrier accounting stores in relative amounts corresponding to previous usage of postage value for each of the respective carriers.

14. The apparatus of claim 12, wherein the control module is configured to re-credit the credit registers of the carrier accounting stores in relative amounts as defined by a user.

15. The apparatus of claim 1, wherein at least ones of the postage indicia include a banner element.

16. The apparatus of claim 15, wherein the banner element is common to all of the carriers.

17. The apparatus of claim 15, wherein the banner element is unique to the respective carrier.

18. The apparatus of claim 1, wherein the printing module includes a sorter for sorting franked mail items by carrier.

19. A method of franking mail items with postage indicia for one of a plurality of mail carriers, the method comprising the steps of:
storing print information unique to each of the carriers;
storing print information common to each of the carriers;
for a mail item, selecting one of the carriers;
generating a carrier-specific element utilizing the unique print information for the respective carrier;
generating a common element utilizing the common print information; and
franking the mail item with a postage indicium including the carrier-specific element and the common element.

20. The method of claim 19, wherein the carrier selection step comprises the step of:
a user selecting one of the carriers.

21. The method of claim 20, wherein the carrier selection step comprises the steps of:
generating a ranked list of the carriers; and
a user selecting one of the carriers.

22. The method of claim 21, wherein the ranked list of carriers is determined according to at least one user-defined preference.

23. The method of claim 19, wherein the carrier selection step comprises the step of:
automatically selecting one of the carriers.

24. The method of claim 23, wherein the carrier is selected according to at least one user-defined preference.

25. The method of claim 24, further comprising the steps of:
storing user-defined preferences for users;
inputting a user-identification code; and
determining the user-defined preferences for carrier selection from the user-identification code.

26. The method of claim 25, wherein the user-identification code comprises a personal identification number (PIN).

27. The method of claim 19, wherein a batch of mail items is franked with postage indicia for the same carrier.

28. The method of claim 19, further comprising the steps of:
maintaining credit registers for the respective carriers, each credit register storing a value representative of a value of postage available to be printed for the respective carrier; and
maintaining a bank credit register storing a common banked value of credit which is utilized in crediting the respective credit registers.

29. The method of claim 28, further comprising the step of:
re-crediting the credit registers in relative amounts corresponding to previous usage of postage value for each of the respective carriers.

30. The method of claim 28, further comprising the step of:
re-crediting the credit registers in relative amounts as defined by a user.

31. The method of claim 19, wherein at least ones of the postage indicia include a banner element.

32. The method of claim 31, wherein the banner element is common to all of the carriers.

33. The method of claim 31, wherein the banner element is unique to the respective carrier.

34. The method of claim 19, further comprising the step of:
automatically sorting franked mail items by carrier.
